(19) United States
(12) Patent Application Publication
(10) Pub. No.: US 2013/0267141 A1
(43) Pub. Date: Oct. 10, 2013

(54) FOOT MAT OF AUTOMOBILE

(71) Applicant: MING-SHUN YANG, Taipei (TW)

(72) Inventor: MING-SHUN YANG, Taipei (TW)

(21) Appl. No.: 13/442,879

(22) Filed: Apr. 10, 2012

(51) Int. Cl. B32B 5/02

(52) U.S. Cl. 442/315; 428/317.1

(57) ABSTRACT

A foot mat is formed by combining at least a topmost top sheet layer, a fibrous material layer, and a foamed material layer. The top sheet layer is made of thermoplastic polyurethane that is prepared with the constituent components including 10-84% polyol, 15-55% MDI, and 1-75% 1,4BG and shows properties of wear resistance, bending resistance, oil staining resistance, and corrosion resistance and has excellent machinability. Thus, the foot mat so made shows excellent advantages of being not damaged by scratching, improved durability, resistance against staining caused by oil and dust, and being easy to clean.

### TECHNICAL FIELD OF THE INVENTION

The present invention generally relates to a foot mat of automobile, which uses the inherent properties of constituent materials to make a mat that shows excellent advantages of comfortableness, durability, and staining resistance and is applicable to the floor of various automobiles or the likes.

### DESCRIPTION OF THE PRIOR ART

To improve the quality of internal decoration of automobiles and also to improve the comfortableness of riding, blankets are commonly laid on the chassis of automobile. These blankets provide the benefits of aesthetics and comfortableness. However, the blanket may easily get stained. Thus, users often place a detachable foot mat on the blanket, whereby when a passenger sits in the automobile, the dirt carried on the shoe sole can be kept on the foot mat without directly contaminating the in-automobile blanket. The foot mat can be removed for cleansing or replacing when desired, making it convenient and easy to use.

A great variety of different foot mats are available for automobiles, such as blanket-made mat that was used in the early days. Such a foot mat comprises a lot of comfortable clusters of fibers distributed on the surface thereof, which are effectively to scrape off dirt of shoe sole. However, such fiber clusters are very poor in resisting oil staining and may hide dirt and dust in the fiber clusters, making it hard to completely clean and thereby easily leading to shortcomings of getting moldy and emission of odors that severely affect internal sanitation of the automobile. Consequently, such a conventional foot mat must be replaced very frequently, but this brings the issue of garbage and environmental conservation and is not economically effective. Subsequently developed foot mats are made of a base material of polyvinyl chloride, rubber, and synthetic rubber. Such a material is heavy and may release toxicant gas and odors when heated by the high inside temperature of a closed automobile, and may thus affect the health of the driver and passengers. Further, after a long term of use, corrosion may occur because of scratch mark of shoe and oil stain, rainwater, snow, and muddy substance and staining may be left on the surface of the foot mat, causing severe influence on the internal aesthetics of the automobile.

In view of these problems, the present invention aims to provide a foot mat made of a uniquely prepared formula of material that shows the properties of wear resistance, bending resistance, oil staining resistance, and corrosion resistance, so that the foot mat so made shows excellent advantages of being not damaged by scratching, improved durability, resistance against staining caused by oil and dust, and being easy to clean.

### SUMMARY OF THE INVENTION

An object of the present invention is to provide a structure of mat that shows properties of wear resistance, bending resistance, oil staining resistance, and corrosion resistance and has excellent machinability, so that the mat so made realizes comfortableness, aesthetics, durability, and utility.

To achieve the above object, the present invention provides a foot mat of automobile, which comprises a topmost top sheet layer, which is made of thermoplastic polyurethane (TPU) that is prepared with the constituent components including 10-90% polyol, 15-55% MDI, and 1-80% 1,4BG, and preferably prepared with these constituent components of the following percentages 55% polyol, 35% MDI, and 10% 1,4BG, and at least one fibrous material layer and one foamed material layer attached to an underside of the top sheet layer. The fibrous material layer is made of polyethylene fibers, polypropylene fibers, polyester fibers, nylon fibers, or natural fibers, such as fibrous fabric made of polyester cotton and natural cotton. The foamed material layer is made of a cross-linked polyethylene (XPE) foamed board, polyethylene (PE) foamed board, ethylene vinyl acetate (EVA) copolymer, or polyurethane (PU) foamed board, so as to form a structure of foot mat of automobile that is comfortable, durable, and practical. Further, the foot mat may comprise a skidding-resistant layer that is attached to an undersurface of the foamed material layer to improve skidding resistance of the foot mat.

Further, the foot mat discussed above may be made in the form of a flat mat or a mat body that comprises a three-dimensional mat that has a center-recessed and circumference-raised configuration to facilitate internal cleaning operation of the automobile.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing the structure of a foot mat of automobile according to a first embodiment of the present invention.

FIG. 2 is a cross-sectional view, in an exploded form, showing the foot mat of automobile according to the first embodiment of the present invention.

FIG. 3 is a partial enlarged view, in a sectioned form, showing the foot mat of automobile according to the first embodiment of the present invention.

FIG. 4 is an exploded view showing the structure of a foot mat of automobile according to a second embodiment of the present invention.

FIG. 4A is a partial enlarged view of the foot mat of automobile shown in FIG. 4.

FIG. 5 is a partial enlarged view, in a sectioned form, showing the foot mat of automobile according to the second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

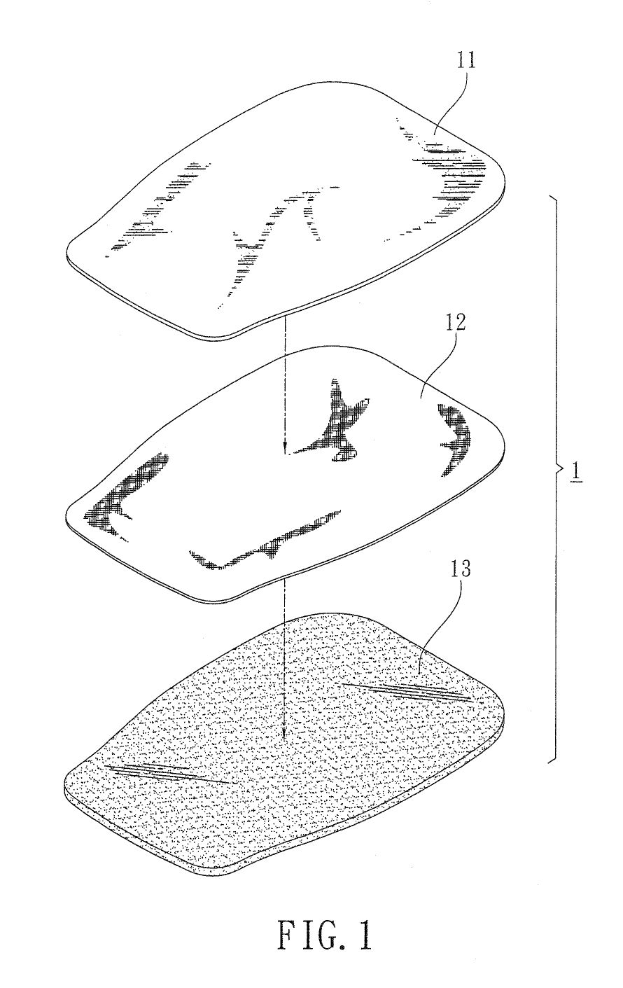

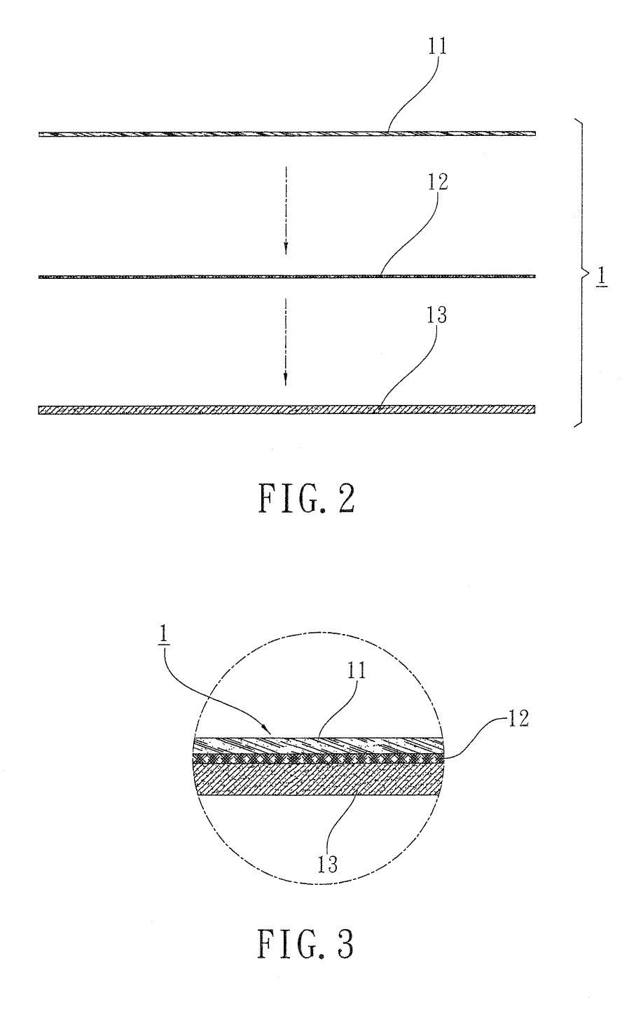

Referring to FIGS. 1-3, the present invention provides a foot mat 10 of automobile. The foot mat 10 is formed by combining at least a top sheet layer 11 that is set at the topmost portion, an intermediate fibrous material layer 12, and a foamed material layer 13 that is located at the bottom most portion.

The top sheet layer 11 is made of thermoplastic polyurethane (I PU) that is prepared with the constituent components including 10-90% polyol (such as polyester polyol), 15-55% diisocyanate (such as methylenediphenyl diisocyanate, MDI), and 1-80% 1,4-butanediol (1,4BG), and is preferably prepared with these constituent components of the following percentages 55% polyol, 35% MDI, and 10% 1,4BG. The TPU material shows excellent properties of wear resistance, bending resistance, oil staining resistance, and corrosion resistance, and has an advantage of excellent machinability.

The fibrous material layer 12 is made of polyethylene fibers, polypropylene fibers, polyester fibers, nylon fibers, or natural fibers, such as fibrous fabric made of polyester cotton and natural cotton.

The foamed material layer 13 is made of a cross-linked polyethylene (XPE) foamed board, polyethylene (PE) foamed board, ethylene vinyl acetate (EVA) copolymer, or polyurethane (PU) foamed board.

These layers are bonded together through application of adhesives, lamination with extrusion machine, firing melt molding to form a flat composite material, which can be subsequently machined to form a three-dimensional foot mat having a center-recessed and circumference-raised configuration. The foot mat so made is soft and comfortable and is also not susceptible to damage caused by scratching, so that the durability is improved and advantages of being resistant to stained by oil and dust and being easy to clean can be achieved.

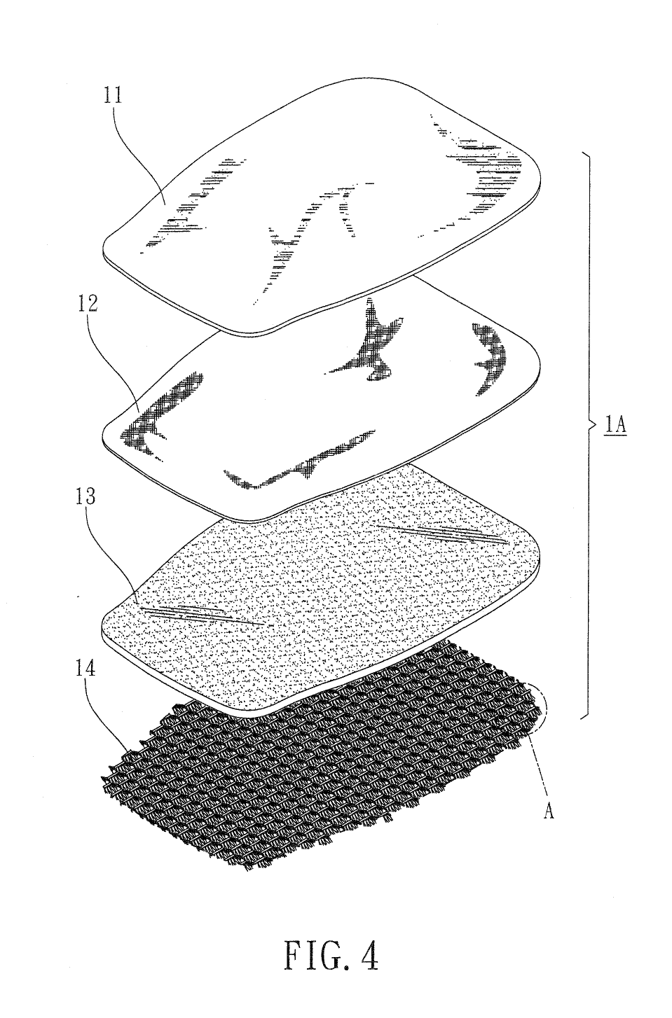

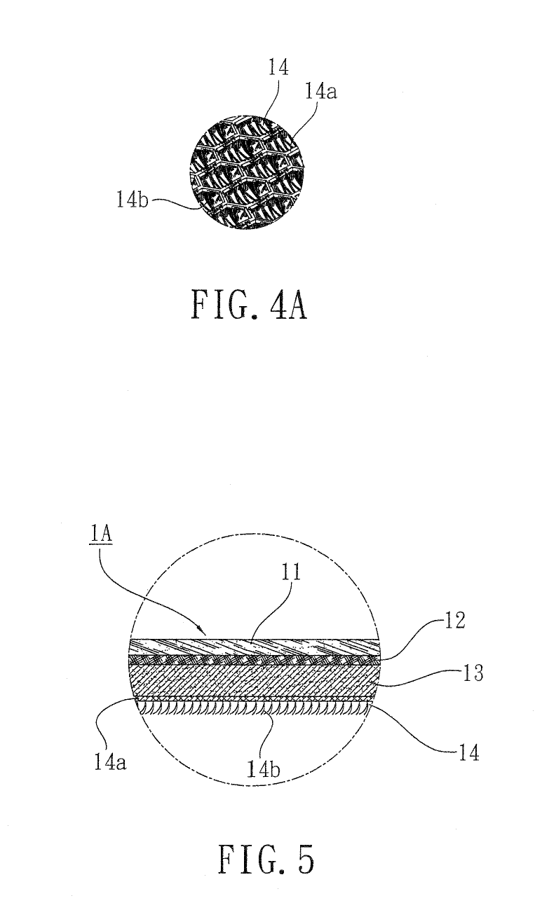

FIGS. 4 and 5 show another embodiment of the present invention. The embodiment provides a foot mat 1A, which, besides the topmost top sheet layer 11, the fibrous material layer 12, and the foamed material layer 13, comprises a skidding-resistant layer 14 arranged on the undersurface of the foamed material layer 13. The skidding-resistant layer 14 comprises an attachable skidding-resistant material and, as shown in FIG. 4A, comprises a knitted or woven section 14a and a plurality of synthetic fibrous yarns 14b that has a predetermined height and stiffness and projects beyond the knitted section. The fibrous yarns 14b can be made of nylon plastic material, polyester materials, or polypropylene (PP) materials, or can be a fibrous fabric made of polyethylene (PE) material with the knitted section 14a as an attaching surface, which is similarly subjected to bonding through application of adhesives, lamination with extrusion machine, firing melt molding so as to bond the skidding-resistant layer 14 to the undersurface of the foamed material layer 13 to provide the foot mat so made with excellent skidding resistance with respect to blankets, flannel blanket, or boucle fabric, allowing of repeated attachment to/detachment from an in-automobile blanket without causing damage to the blanket.

In summary, the present invention provides a foot mat of automobile, which, although simple in structure, provides excellent property that shows advantages of comfortableness, durability, and utility, and is thus applicable to the manufacture of foot mats for various automobile.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A foot mat of automobile, which is formed by combining at least a topmost top sheet layer, an intermediate fibrous material layer, and a bottommost foamed material layer, these layers being bonded together through application of adhesives, lamination with extrusion machine, firing melt molding, characterized in that:
the top sheet layer is made of TPU that is prepared with the constituent components including 10-84% polyol, 15-55% MDI, and 1-75% 1,4BG and shows excellent properties of wear resistance, bending resistance, oil staining resistance, and corrosion resistance.

2. The foot mat of automobile according to claim 1, wherein the TPU of the top sheet layer is prepared with the constituent components of the following percentages 55% polyol, 35% MDI, and 10% 1,4BG.

3. The foot mat of automobile according to claim 1, wherein the fibrous material layer is made of polyethylene fibers, polypropylene fibers, polyester fibers, nylon fibers, or natural fibers.

4. The foot mat of automobile according to claim 1, wherein the foamed material layer is made of a cross-linked polyethylene (XPE) foamed board, polyethylene (PE) foamed board, ethylene vinyl acetate (EVA) copolymer, or polyurethane (PU) foamed board.

5. The foot mat of automobile according to claim 1, wherein a skidding-resistant layer attached to an undersurface of the foamed material layer.

6. The foot mat of automobile according to claim 5, wherein the skidding-resistant layer consists of an attachable skidding-resistant material and structurally comprises a knitted section and a plurality of synthetic fibrous yarns that projects beyond the knitted section.
